(19) United States
(12) Patent Application Publication
(10) Pub. No.: US 2010/0189326 A1
(43) Pub. Date: Jul. 29, 2010

(54) COMPUTER-AIDED DETECTION OF FOLDS IN MEDICAL IMAGERY OF THE COLON

(76) Inventors: Ryan McGinnis, London, OH (US); Kevin Woods, Beavercreek, OH (US); Senthil Periaswamy, Beavercreek, OH (US); Robert L. Van Uitert, Hollis, NH (US)

Correspondence Address: FOLEY HOAG, LLP;PATENT GROUP, WORLD TRADE CENTER WEST, 155 SEAPORT BLVD, BOSTON, MA, 02110, US

(21) Appl. No.: 12/362,111

(22) Filed: Jan. 29, 2009

(51) Int. Cl. G06K 9/00

(52) U.S. Cl. 382/131

(57) ABSTRACT

The application discloses computer-based apparatus and methods for analysis of images of the colon to assist in the detection of colonic polyps. The apparatus and methods include the detection, classification and display of candidate colonic folds.

### FIELD

The application discloses computer-based apparatus and methods for analysis of images of the colon to assist in the inspection of the colon.

### BACKGROUND

Colon cancer is the second leading cause of cancer death among men and women in the United States. The identification of suspicious polyps in the colonic lumen may be a critical first step in detecting the early signs of colon cancer. Many colon cancers can be prevented if precursor colonic polyps are detected and removed.

Computed tomographic (CT) and magnetic resonance (MR) colonography, two new “virtual” techniques for imaging the colonic lumen, have emerged as alternatives to the invasive optical colonoscopy procedure, which has traditionally been considered the gold standard for viewing the colon. CT imaging systems, for example, may acquire a series of cross-sectional images (i.e., slices) of the abdomen using scanners and x-rays. Computer software may be used to construct additional imagery from the slices, such as a three-dimensional (3-D) volume of the abdominal region. A physician may inspect the imagery for indicators of colonic polyps.

The human colon has many folds that complicate the physician's inspection procedure. While most folds are considered healthy tissue, polyp-like anomalies may form either on or near folds and should be carefully examined by a physician. As a result, a physician may frequently change the viewing angle while inspecting the colon, which may undesirably increase the physician's overall interpretation time. Even still, physicians may fail to detect polyps due to folds, which may be attributed in part to the long interpretation times required to inspect a colon, and to human error associated with such inspection, such as error resulting from fatigue.

Researchers have begun exploring automatic, computer-implemented approaches for assisting the inspecting physician who may miss polyps due to folds. Several notable approaches will now be discussed in brief detail.

In “Colon Straightening Based on an Elastic Mechanics Model,” Biomedical Imaging: Nano to Macro, 2004. IEEE International Symposium on, Publication Date: 15-18 Apr. 2004, page(s): 292-295, Vol. 1, Zhang et al. “flatten” the folds of a colon surface, which may provide a form of fold subtraction. While interesting in theory, physicians may not accept the distorted colon for purposes of inspection and diagnosis, as artifacts may be introduced by the algorithm. Furthermore, any processing to correlate the results of the flattened and original colon may be extremely sensitive to the algorithm used. Thus, a solution that does not distort the colon imagery may be more desired by the physician.

In U.S. Pat. No. 7,286,693, “Medical viewing system and image processing method for visualization of folded anatomical portions of object surface,” Makram-Ebeid et al. detect folded objects in the colon that may have a “hidden portion,” such as an area that may be hidden because it appears between the surface and a fold of the colon. Hidden portions of a colon have a high likelihood of being missed by an inspecting physician. The detected folded objects are then displayed in various ways to capture the attention of the inspecting physician. Measurements regarding both the folded objects and their hidden portions are also displayed as output. While Makram-Ebeid's approach identifies folded portions of a colon that require careful inspection, the approach is limited to the detection of only those folds that have a hidden portion. There may be many folds in a colon that do not have a hidden portion but that may still be of interest to the physician. For example, folds adjacent or near to a polyp-like anomaly may be of particular interest. Thus, a means for identifying folds of a colon, regardless of whether folds have a “hidden portion” or not, is still desired. Furthermore, while Makram-Ebeid's approach calls attention to specific folded portions that may be of interest, the physician may still be required to change the viewing angle of the colon to properly inspect the hidden portion of the fold. A solution that reduces or eliminates the need for the physician to change the viewing angle around colonic folds would be desirable.

Two automated methods for detecting colonic folds (including those folds without a “hidden portion”) can be seen in the prior art. In “Tissue Classification Based on 3D Local Intensity Structures for Volume Rendering,” IEEE Transactions on Visualization and Computer Graphics, April-June 2000, Vol. 6:2, pp. 160-180, Sato et al. teach a sheet structure enhancement filter method for detecting folds. In “Haustral fold analysis may aid detection of flat colorectal polyps,” IEICE Tech. Rep., vol. 108, no. 131, MI2008-31, pp. 59-64, July 2008, Oda et al. improve on Sato's method by using a ridge structure enhancement (RSE) filter method for detecting folds. Curvature-based fold detection methods such as these may have inherent limitations due to tortuous colons, adequacy of colonic distention, and the complexity of fold composition (e.g., shapes and sizes). In clinical practice, insufflation may be performed with highly varying accuracy and thus, fold distention may also be highly variable. Furthermore, in clinical practice, a wide range of colon and fold compositions may be encountered. Thus, there is a need for an alternative, automated method of identifying folds that is not dependent on adequate colonic distention and is applicable to a wider range of colon and fold compositions.

It is therefore an object of this disclosure to automatically compute and output colonic fold information in various ways that may improve a physician's ability to inspect colon imagery.

It is another object of this disclosure to depict colonic folds in various ways that may reduce the time it takes a physician to inspect areas around colonic folds.

It is yet another object of this disclosure to detect colonic folds using a method that is not dependent on consistently adequate colonic distention and is applicable to a wider range of colon and fold compositions.

### SUMMARY

Disclosed are computer-implemented methods of presenting colonic folds in a colon under study to a user.

The methods may comprise receiving, through at least one input device, digital imagery representing at least a portion of a colon; using at least some of said digital imagery, detecting, in at least one processor, at least one candidate colonic fold in said at least a portion of a colon; classifying, in at least one processor, at least one of said candidate colonic folds as a colonic fold; and outputting, through at least one output device, information identifying said at least one candidate colonic fold which was classified as a colonic fold.

Detecting at least one candidate colonic fold may comprise performing a colonic wall segmentation step; and based upon the colonic wall segmentation, performing a candidate fold segmentation step, wherein a colonic wall segmentation may include soft tissue objects protruding from said wall into the lumen of said colon. Performing the colonic wall segmentation step may comprise performing at least one of an active contour method, a level set method, and a CT value and CT gradient method. Performing the colonic wall segmentation step may comprise performing a colon lumen segmentation step; and based upon the colonic lumen segmentation, performing a colon wall identification step. Performing the colonic lumen segmentation step may comprise segmenting a representation of air of said colon; and segmenting a representation of fluid of said colon. Performing the colonic wall identification step may comprise performing at least one of a local convex hull operation and a morphological closing operation. Performing the candidate fold segmentation step may comprises performing an erosion of the colonic wall; and based on the colonic wall erosion, performing a thresholding operation on the eroded colon wall. Performing an erosion of the colonic wall may comprise performing at least one of a morphological erosion, an active contour, or a distance transform operation. Performing an erosion of the colonic wall may comprise performing a first operation on said colon wall to identify a body of said at least one candidate colonic fold; and performing a second operation on said colon wall to identify a base of said at least one candidate colonic fold.

Classifying at least one of said candidate colonic folds as a colonic fold may comprise performing at least one of a distance feature extraction step and a non-distance feature extraction step on the candidate colonic fold; and based upon the at least one of the distance feature extraction step and the non-distance feature extraction step performed, performing a classification step. Performing a distance feature extraction step may comprise computing at least one distance measurement from a common voxel point to voxel points along a boundary where said candidate colonic fold meets said colon wall. Performing a non-distance feature extraction step may comprise computing at least one of a volume feature, a feature describing the amount the candidate colonic fold touches the colonic wall, a shape index feature, a curvature feature, and a texture feature. Performing a classification step may comprises computing a discriminant score from at least one of a distance feature measurement extracted and a non-distance feature measurement extracted; and classifying said at least one candidate colonic fold based on said discriminant score computed. The classification may be a binary decision as to whether the candidate colonic fold is a colonic fold. The classification may be a probability as to whether the candidate colonic fold is a colonic fold.

Outputting may comprise displaying digital imagery representing at least a portion of the colon on at least one output device; and specially depicting said at least one candidate colonic fold which was classified as a colonic fold in said at least a portion of the colon displayed. Outputting may further comprise, in said special depiction of said at least one candidate colonic fold which was classified as a colonic fold, displaying the said at least one candidate colonic fold which was classified as a colonic fold at least partially transparently. At least a portion of the digital imagery representing at least a portion of a colon may derive from a non-invasive imaging method. The non-invasive imaging method may be selected form the set composed of CT scanning and MRI imaging.

Also disclosed is a computer-readable medium having computer-readable instructions stored thereon which, as a result of being executed in a computer system having at least one processor, at least one output device and at least one input device, instruct the computer system to perform the above methods.

Also disclosed is a computer system for presenting colonic folds in a colon under study to a user, comprising at least one processor, at least one input device and at least one output device, so configured that the computer system is operable to perform the above methods.

The methods may comprise receiving, through at least one input device, digital imagery representing at least a portion of a colon; using at least some of said digital imagery, detecting, in at least one processor, at least a portion of a colonic wall in said at least a portion of a colon; segmenting, in at least one processor, at least one candidate colonic fold from said at least a portion of a colonic wall; and outputting, through at least one output device, information identifying said at least one candidate colonic fold which was segmented from said at least a portion of a colonic wall.

Detecting at least a portion of a colonic wall in said at least a portion of a colon may comprise performing at least one of an active contour method, a level set method, and a CT value and CT gradient method. Detecting at least a portion of a colonic wall in said at least a portion of a colon may comprise performing a colon lumen segmentation step; and based upon the colonic lumen segmentation, performing a colon wall identification step. Performing the colonic lumen segmentation step may comprise segmenting a representation of air of said colon; and segmenting a representation of fluid of said colon. Performing the colonic wall identification step may comprise performing at least one of a local convex hull operation and a morphological closing operation.

Segmenting at least one candidate colonic fold from said at least a portion of a colonic wall may comprise performing an erosion of the colonic wall; and based on the colonic wall erosion, performing a thresholding operation on the eroded colon wall. Performing an erosion of the colonic wall may comprise performing at least one of a morphological erosion, an active contour, or a distance transform operation. Performing an erosion of the colonic wall may comprises performing a first operation on said colon wall to identify a body of said at least one candidate colonic fold; and performing a second operation on said colon wall to identify a base of said at least one candidate colonic fold.

The method may further comprise classifying, in at least one processor, at least one of said candidate colonic folds segmented from said at least a portion of a colonic wall as a colonic fold. Classifying at least one of said candidate colonic folds as a colonic fold may comprise performing at least one of a distance feature extraction step and a non-distance feature extraction step on the candidate colonic fold; and based upon the at least one of the distance feature extraction step and the non-distance feature extraction step performed, performing a classification step.

Outputting may comprise displaying digital imagery representing at least a portion of the colon on at least one output device; and specially depicting said at least one candidate colonic fold which was classified as a colonic fold in said at least a portion of the colon displayed.

Also disclosed is a computer-generated user interface for presenting a graphical representation of a colon, the user interface comprising a depiction of the colon; wherein regions of the colon segmented as colonic folds are displayed at least partially transparent.

### BRIEF DESCRIPTION OF THE DRAWINGS

FIG. 1 is a block diagram of an illustrative system for acquiring and processing a digital representation of a colon.

FIG. 2 is a flowchart showing a method of automatically detecting and displaying folds of interest in medical imagery of a colon.

FIG. 3 is a virtual endoscopic image of a colon illustrating exemplary folds.

FIG. 4 is a flowchart showing a method that may be performed to segment candidate colonic folds in accordance with certain embodiments of the systems and methods disclosed herein.

FIG. 5 is a flowchart showing a method that may be performed to segment a colonic wall in accordance with certain embodiments of the systems and methods disclosed herein.

FIG. 6 is a sagittal image slice illustrating a portion of a colon and, in particular, a colonic lumen, a colonic lumen/wall boundary, and a colonic wall that may be identified in accordance with certain embodiments of the systems and methods disclosed herein.

FIG. 7 is a sagittal image slice illustrating a portion of a colon and, in particular, a morphologically closed colonic wall that may be identified in accordance with certain embodiments of the systems and methods disclosed herein.

FIG. 8 is a sagittal image slice illustrating a portion of a colon and, in particular, an eroded colonic wall that may be identified in accordance with certain embodiments of the systems and methods disclosed herein.

FIG. 9 is a sagittal image slice illustrating a plurality of candidate fold objects that may be segmented from an eroded colonic wall in accordance with certain embodiments of the systems and methods disclosed herein.

FIG. 10 is a flowchart showing an exemplary method of classifying candidate fold objects in accordance with certain embodiments of the systems and methods disclosed herein.

FIG. 11A is a histogram of distance labels computed for an exemplary colonic fold in accordance with certain embodiments of the systems and methods disclosed herein.

FIG. 11B is a histogram of distance labels computed for an exemplary non-colonic fold object in accordance with certain embodiments of the systems and methods disclosed herein.

FIG. 11C is a histogram of distance labels computed for an exemplary colonic fold in accordance with certain embodiments of the systems and methods disclosed herein.

FIG. 12 is a flowchart showing an alternate method of automatically segmenting and displaying folds of interest in medical imagery of a colon in accordance with certain embodiments of the systems and methods disclosed herein.

### DETAILED DESCRIPTION OF EMBODIMENTS

In the following detailed description of embodiments, reference is made to the accompanying drawings that form a part hereof, and in which are shown, by way of illustration and not by way of limitation, specific embodiments in which the methods and systems disclosed herein may be practiced. It is to be understood that other embodiments may be utilized and that logical, mechanical, and electrical changes may be made without departing from the scope of the methods and systems disclosed herein.

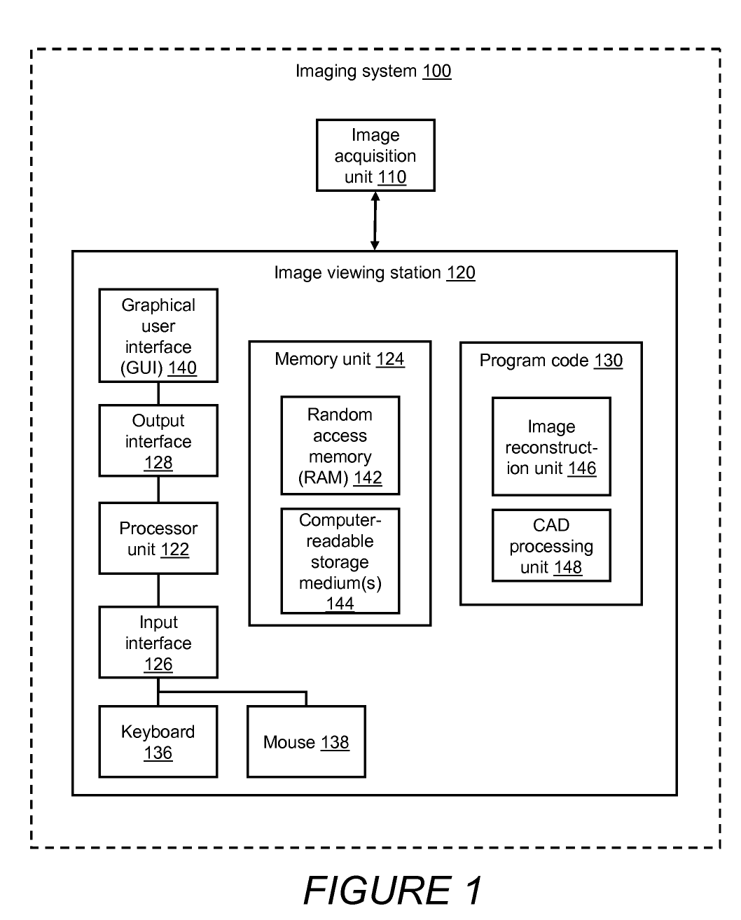

This disclosure is directed to a system for and method of automatically detecting and outputting the folds of an anatomical colon. FIG. 1 is a block diagram of an illustrative system 100 for acquiring and processing colonography medical imagery. More specifically, system 100 may be suitable for detecting and outputting the folds of an anatomical colon in accordance with the methods disclosed herein. The system described is for reference purposes only. Other systems may be used in carrying out embodiments of the methods disclosed herein.

System 100 includes an image acquisition unit 110 for performing a medical imaging procedure of a patient's colon and an image viewing station 120 for processing and displaying colon imagery to a physician or other user of the system. Image acquisition unit 110 may connect to and communicate with image viewing station 120 via any type of communication interface, including but not limited to, physical interfaces, network interfaces, software interfaces, and the like. The communication may be by means of a physical connection, or may be wireless, optical or of any other means. It will be understood by a person of skill in the art that image acquisition unit 110 and image viewing station 120 may be deployed as parts of a single system or, alternatively, as parts of multiple, independent systems, and that any such deployment may be utilized in conjunction with embodiments of the methods disclosed herein. If image acquisition unit 110 is connected to image viewing station 120 by means of a network or other direct computer connection, the network interface or other connection means may be the input device for image viewing station 120 to receive imagery for processing by the methods and systems disclosed herein. Alternatively, image viewing station 120 may receive images for processing indirectly from image acquisition unit 110, as by means of transportable storage devices (not shown in FIG. 1) such as but not limited to CDs, DVDs or flash drives, in which case readers for said transportable storage devices may function as input devices for image viewing station 120 for processing images according to the methods disclosed herein.

Image acquisition unit 110 is representative of a system that can acquire imagery of a patient's abdominal region using non-invasive imaging procedures (e.g. a virtual colonography imaging procedure). Such a system may use computed tomography (CT), magnetic resonance imaging (MRI), or another suitable method for creating images of a patient's abdominal and colonic regions as will be known to a person of skill in the art. Examples of vendors that provide CT and MRI scanners include the General Electric Company of Waukesha, Wis. (GE); Siemens AG of Erlangen, Germany (Siemens); and Koninklijke Philips Electronics of Amsterdam, Netherlands.

Image viewing station 120 is representative of a system that can analyze the medical imagery for anomalies such as folds and polyps and output both the medical imagery and the results of its analysis. Image viewing station 120 may further comprise a processor unit 122, a memory unit 124, an input interface 126, an output interface 128, and program code 130 containing instructions that can be read and executed by the station. Input interface 126 may connect processor unit 122 to an input device such as a keyboard 136, a mouse 138, and/or another suitable device as will be known to a person of skill in the art, including for example and not by way of limitation a voice-activated system. Thus, input interface 126 may allow a user to communicate commands to the processor. One such exemplary command is the execution of program code 130 tangibly embodying the automated fold detection steps disclosed herein. Output interface 128 may further be connected to processor unit 122 and an output device such as a graphical user interface (GUI) 140. Thus, output interface 128 may allow image viewing station 120 to transmit data from the processor to the output device, one such exemplary transmission including medical imagery and anomalies for display to a user on GUI 140.

Memory unit 124 may include conventional semiconductor random access memory (RAM) 142 or other forms of memory known in the art; and one or more computer readable-storage mediums 144, such as a hard drive, floppy drive, read/write CD-ROM, tape drive, flash drive, optical drive, etc. Stored in program code 130 may be an image reconstruction unit 146 for constructing additional imagery from the images acquired by image acquisition unit 110; and a computer-aided detection (CAD) processing unit 148 for automatically detecting anomalies representing folds and, in certain embodiments, anomalies representing polyps of a colon, in accordance with the methods disclosed herein.

It is further noted that while image reconstruction unit 146 and CAD processing unit 148 are depicted as being components within image viewing station 120, one skilled in the art will appreciate that such components may be deployed as parts of separate computers, computer processors, or computer systems. For example, image reconstruction unit 146 may be deployed as part of a virtual colonography review workstation system (e.g., V3D-Colon™ from Viatronix, Inc. of Stony Brook, N.Y.).

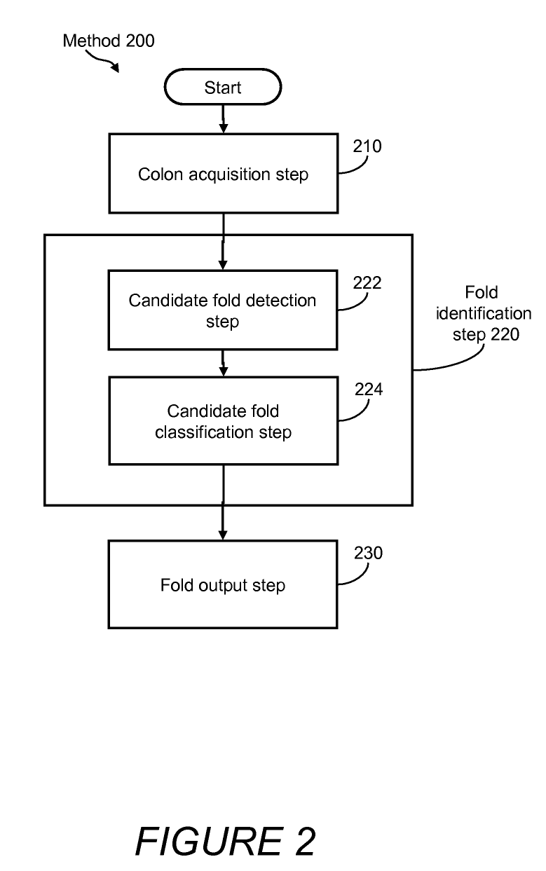

FIG. 2 is a flowchart showing a method 200 of automatically detecting and outputting the folds of an anatomical colon according to certain embodiments of the methods and systems disclosed herein. The methods illustrated in FIG. 2 may be performed using system 100 or other suitable computer system. As shown in FIG. 2, the overall steps performed in method 200 include a colon acquisition step 210 in which at least one digital representation of a patient's colon is acquired; a fold identification step 220 in which folds in the acquired colon are automatically identified with sufficient accuracy at clinically acceptable processing speeds; and a fold output step 230 in which information regarding the identified folds are output to a physician. Fold identification step 220 further includes a candidate fold detection step 222 that automatically detects soft tissue objects protruding into and/or crossing the colonic lumen; and a candidate fold classification step 224 that classifies each detected object based on features characterizing the likelihood that the object is a fold. These steps will now be described in further detail.

In colon acquisition step 210, medical image data representing a colon, or at least a portion of a colon, may be received in a memory such as memory unit 124. In certain embodiments, the medical image data may be a plurality of cross-sectional, two-dimensional (2-D) images of a patient's abdomen. Such imagery may be generated by performing an abdominal scan procedure on a patient using image acquisition unit 110 or other suitable imaging system. In certain other embodiments, the medical image data may be a three-dimensional (3-D) volumetric image or “volume” of the patient's abdomen. A suitable volumetric image may be constructed from the acquired cross-sectional images using computer software. For example, cross-sectional images generated using image acquisition unit 110 may be transferred to image viewing station 120, whereby image reconstruction unit 146 may construct a 3-D volume of the abdominal region by performing a filtered backprojection algorithm on the cross-sectional images as is known in the art. The volumetric image may be comprised of a series of slices. By way of a non-limiting example, each slice image in the volume may be constructed at 512×512 pixels and a spatial resolution of 0.75 millimeters×0.75 millimeters, and the medical image volume may be comprised of a total of 300-600 slices with a spatial resolution of 1 millimeter.

In certain embodiments, multiple volume images of all or portions of the same colon may be obtained at colon acquisition step 210. The multiple volumes may be acquired by imaging a patient's colon at different angles. For example, in clinical practice today, it is common to image the patient in the prone and the supine positions. In other embodiments, the multiple volumes may be acquired by imaging a patient's colon at different times. For example, a patient's colon may be imaged at one point in time and then reimaged at a later point in time, such as five or ten years later.

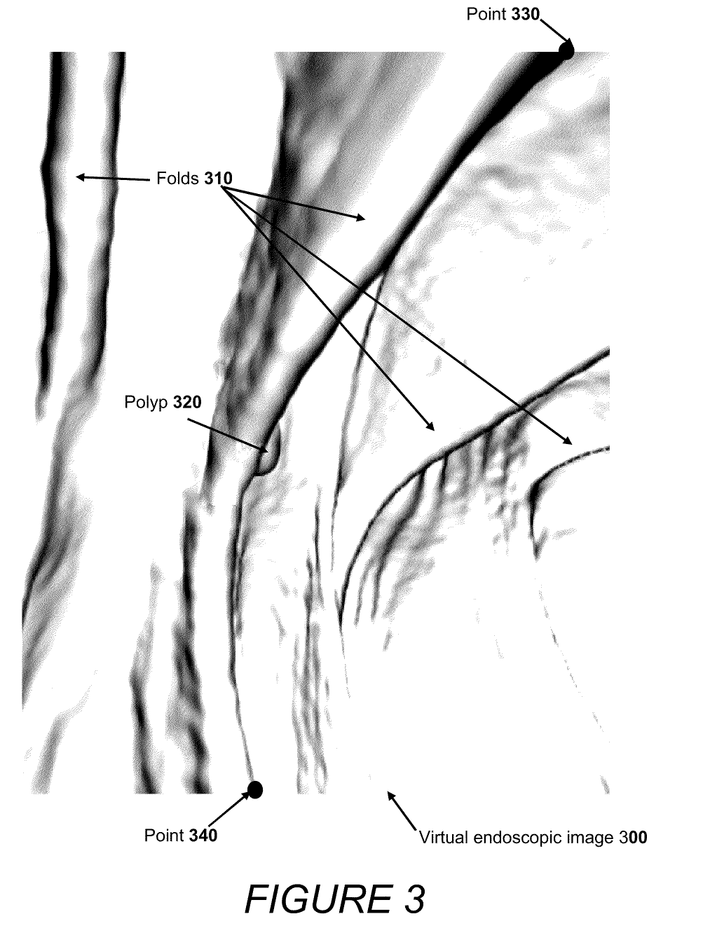

Fold identification step 220 is then performed on all or a portion of the acquired colon imagery to automatically identify folds that may be of interest to a physician. An example of numerous folds 310 of a colon can be seen in FIG. 3, which is a virtual endoscopic image 300 of a portion of a colon. Computer instructions for performing fold identification step 220 may be tangibly embodied in program code that is maintained in CAD processing unit 148, for example. Program code also may be maintained in other locations.

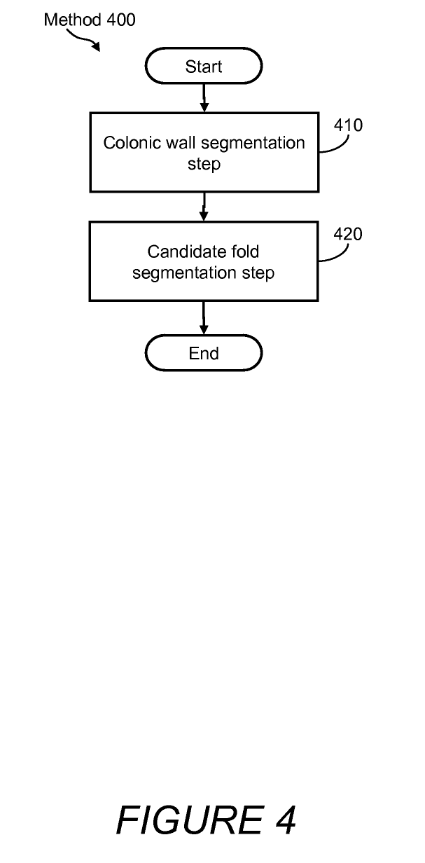

The processing steps performed in candidate fold detection step 222 take advantage of the fact that folds typically will protrude into and/or cross the colonic lumen while other soft tissue objects such as polyps, stool, and normal colon wall perimeter will not, or at least will not to the same extent. FIG. 4 is a flowchart showing a method 400 that may be performed to automatically detect candidate folds at step 222 in accordance with one embodiment of this disclosure. As shown in FIG. 4, the overall steps performed in method 400 include a colonic wall segmentation step 410 for automatically identifying a representation of the wall of the colon and a candidate fold segmentation step 420 for automatically segmenting candidate folds by identifying the soft tissue objects that protrude from the colonic wall into the colonic lumen. These steps will now be described in further detail.

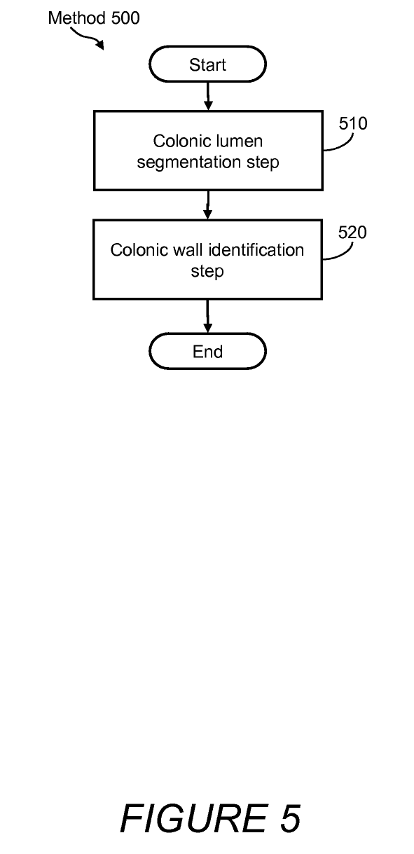

One skilled in the art will appreciate that there are numerous possibilities for performing colonic wall segmentation step 410. By way of several non-limiting examples, a CT value (i.e., intensity) and CT gradient method as described in U.S. Pat. No. 7,379,572, entitled “Method for computer-aided detection of three-dimensional lesions,” a level set method as described in “Detection of Colon Wall Outer Boundary and Segmentation of the Colon Wall Based on Level Set Methods,” Van Uitert et al., Engineering in Medicine and Biology Society, 2006. EMBS '06. 28th Annual International Conference of the IEEE, Publication Date: Aug. 30, 2006-Sep. 3, 2006, page(s): 3017-3020; or an active contour method may be employed. FIG. 5 is a flowchart showing a method 500 that may also be performed to segment the colonic wall at step 410 in accordance with one embodiment of this disclosure. As shown in FIG. 5, the overall steps performed in method 500 include a colonic lumen segmentation step 510 for automatically identifying and segmenting the air and fluid regions of the colonic lumen and a colonic wall identification step 520 for automatically approximating the colonic wall from the segmented colonic lumen. The method steps described in FIG. 5 may be advantageous to perform at colonic wall segmentation step 410 because of the accuracy in which the colonic wall and soft tissue objects can be approximated from a segmented representation of a colonic lumen. For example, techniques such as CT gradient methods may have limitations in noisy colon imagery whereas the techniques described in FIG. 5 are robust, regardless of the amount of noise in the colon imagery. However, it is stressed that such a method is a non-limiting example of ways in which the colonic wall may be segmented. The steps of method 500 will now be described in further detail.

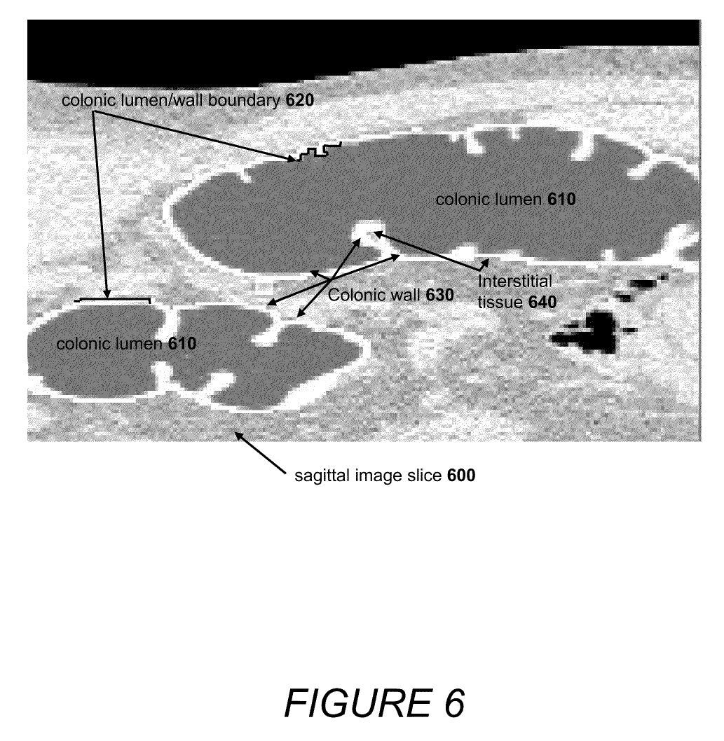

The colonic lumen typically consists of air and fluid. As is known in the art, the image units of colonic air will typically exhibit relatively low intensity values (e.g., less than or equal to −800 Hounsfield Units in CT imagery) when compared with the image units of other objects, such as tagged colonic fluid and the colonic wall. In contrast, the image units of tagged colonic fluid will typically exhibit relatively high intensity values (e.g., 300 Hounsfield Units and greater in CT imagery) when compared with adjacent objects such as colonic air and the colonic wall. One means for identifying and segmenting the colonic lumen at step 510 is described in U.S. Pat. No. 6,246,784, “Method for segmenting medical images and detecting surface anomalies in anatomical structures,” which is incorporated herein by reference. In this patent, a region growing technique is described for identifying and segmenting the air and fluid regions of a colon. FIG. 6 is a sagittal image slice 600 illustrating a portion of a colon. FIG. 6 shows a colonic lumen 610 that may be identified and segmented by performing the steps described hereinabove. Further illustrated is a colonic lumen/wall boundary 620 where the exterior or perimeter of colonic lumen 610 intersects with other tissue. Colonic lumen/wall boundary 620 can be seen between the (dark gray) colonic lumen 610 and the (white) colonic wall 630; two sections of it are further illustrated with solid black lines having no arrows. Note that folds of interest and other soft tissue structures are visible to the eye in FIG. 6 but are not specially identified, as they will not be specially identified by conventional colonic lumen segmentation methods.

Returning to FIG. 5, from the segmented colonic lumen obtained at step 510, a representation of the colonic wall and soft tissue structures that protrude from the colonic wall such as folds, stool, sessile polyps, pedunculated polyps, flat polyps, etc., may then be derived from the colonic lumen boundary in colonic wall identification step 520. One means for identifying this region is to perform a local convex hull operation using the colonic lumen information computed hereinabove as input. (Other methods may also be used.) The colonic lumen typically will be concave where folds and other soft tissue objects protrude into the lumen. The local convex hull operation creates convexity in those areas by analyzing pixels or voxels around the lumen/wall boundary as potential portions of colon wall. One means for performing a local convex hull operation will now be described.

First, a mask representing an estimate of the colonic lumen is received. In FIG. 6, the colon lumen 610 can be seen in a dark gray shade. Each boundary point on the mask is an estimate of the colonic lumen/wall boundary. Each point on the colonic lumen/wall boundary is then analyzed. Other techniques may be used, but in certain embodiments, this may be achieved using a slice-based technique in which a two-dimensional slice is obtained, the lumen/wall boundary is identified (i.e., “traced”) on the slice, and each pixel point on the lumen/wall boundary is evaluated in an iterative (e.g., clockwise) fashion. This may be repeated for all slices so that the entire colonic wall may be estimated. For each boundary pixel point on the lumen mask, the local convex hull algorithm draws a set of lines to all other boundary pixel points within a range of distances along the boundary (the range of distances may be chosen empirically or, alternatively, the range may be derived based on an empirically chosen distance measurement). All pixels not in the colonic lumen mask that are enclosed by a perimeter formed by the drawn lines and the lumen mask boundary would be within the local convex hull of the lumen mask. By selecting an appropriate range of distances, the minimum and maximum size of any convex regions can be controlled. The local convex hull algorithm is thus able to accurately identify the colonic wall and all soft tissue structures (including folds) without segmenting inside the colonic wall itself. Referring again to FIG. 6, a representation of a colonic wall 630 that may be identified by performing the steps described hereinabove is illustrated. Colonic wall 630 can be seen as white. Colonic wall 630 is depicted using a mask that may be formed as an output from the aforementioned operational steps.

Alternatively, colonic wall identification step 520 may also be configured to identify and segment the colonic wall and soft tissue objects from the colonic lumen using morphological closing operation(s). One skilled in the art will appreciate that morphological closing operations represent an alternative means to the convex hull operations described hereinabove.

Returning again to FIG. 4, upon the completion of step 520 in FIG. 5, when compared with other non-fold, soft tissue objects on the colonic wall, such as small sessile polyps and normal colonic perimeter structure, folds will typically extend further into the colonic lumen as illustrated in FIG. 3. Thus, to identify candidate fold objects from the colonic wall based on this anatomical feature, after the completion of step 410, at candidate fold segmentation step 420, an erosion of the colonic wall is first performed such that folds protruding into the colonic lumen are suitably maintained while non-folds are not. By way of a non-limiting example, an erosion of the colonic wall may involve performing one or more morphological operations on the segmented colonic wall. Morphological operations are computationally advantageous such that the systems and methods of this disclosure may be usefully employed in clinical practice without requiring the busy physician to endure long wait times for the results. However, one skilled in the art will appreciate that there are other methods besides morphological operations that may performed to adequately erode the colonic wall. For example, one could first convert a binary mask of the segmented colonic wall into a non-binary mask using a distance transform or active contour method, followed by a thresholding operation that would segment a representation of the colonic wall protruding into the colonic lumen such that folds are suitably maintained.

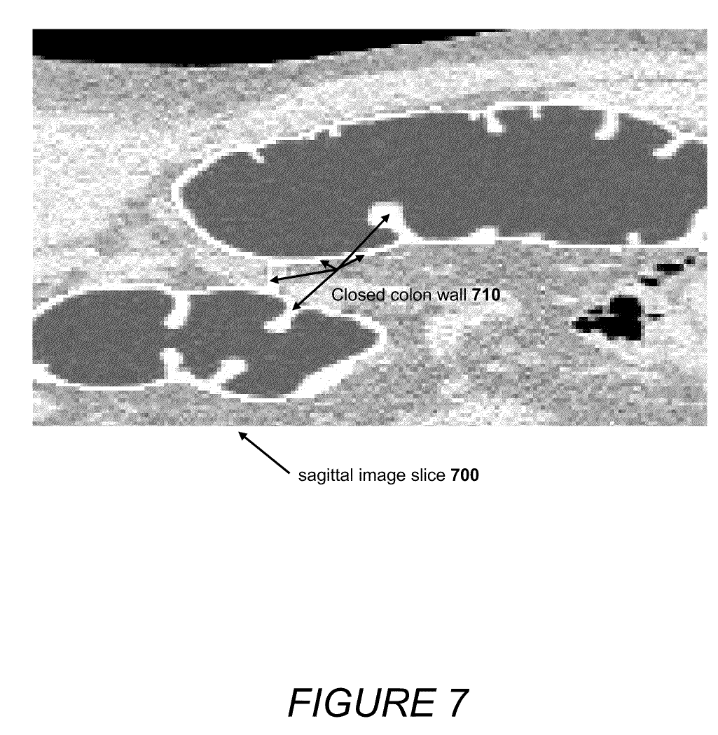

In embodiments where a convex hull algorithm is performed to segment the colonic wall at step 410, candidate fold segmentation step 420 may be configured to perform a morphological closing operation either before or after the convex hull operation as a means to smooth the colonic wall, or reclassify the image units of soft tissue objects to colonic wall that may be inadvertently classified as interstitial tissue. An example of such an artifact is shown in FIG. 6 where a portion of a fold is misclassified as interstitial tissue 640. Such artifacts may occur due to the criterion parameters chosen for the convex hull operation described hereinabove. The structuring element size for the closing operation may also be empirically decided. For example, a closing element size of 7 mm may suitably fill holes on the colonic surface given certain colonic wall segmentation techniques and/or parameters, but other sizes may also be used within the scope of the methods and systems disclosed herein. Alternative to performing the morphological closing operation, one could empirically adjust the criterion parameters used by the convex hull operation to minimize such artifacts. FIG. 7 is a sagittal image slice 700 illustrating a portion of a colon and a closed colonic wall 710 that may be obtained by performing the morphological closing steps described hereinabove. Closed colonic wall 710 is depicted using a mask that may be formed as an output from the aforementioned operational steps. Closed colonic wall 710 is shown in white.

Again referencing FIG. 4, a series of two different morphological erosion operations may be performed to erode the colonic wall at candidate fold segmentation step 420, one of which enables the segmentation of the body of the candidate fold objects and one of which enables the segmentation of the base of the candidate fold objects. The structuring element size for these erosion operations may be empirically decided such that non-fold, soft tissue objects are eroded while folds are maintained. For example, a structuring element size of 9 mm may be suitable for extracting the body of the candidate fold objects, but other sizes may also be used within the scope of the methods and systems disclosed herein. While this morphological erosion operation may segment a majority portion of each fold object, the base of each fold object may not be segmented due to the aggressive size of the structuring element required to segment fold bodies. To segment the base of each fold, a mask representing the colonic wall may be eroded by a smaller, more “conservative” structuring element size (e.g., 5 mm). This conservative approach will segment fold bases, but may also segment extraneous objects such as gradual curvature of the colonic wall or portions of small sessile polyps. In order to append the base of folds without appending such extraneous objects, an overlap technique may be used. In this technique, a mask containing the fold objects, which may be a mask of fold objects derived either before or after candidate fold classification step 224 is performed, is morphologically dilated with a structuring element of suitable size (e.g., 4 mm in a xy-plane and 2 mm in a z-plane). Then, a binary AND operation is performed using the conservatively eroded mask. This yields the folds of the bases that were already in the fold mask. These objects may then be appended to the fold mask as fold bases to segment a suitable representation of folds in the colon that include both the body and base of folds.

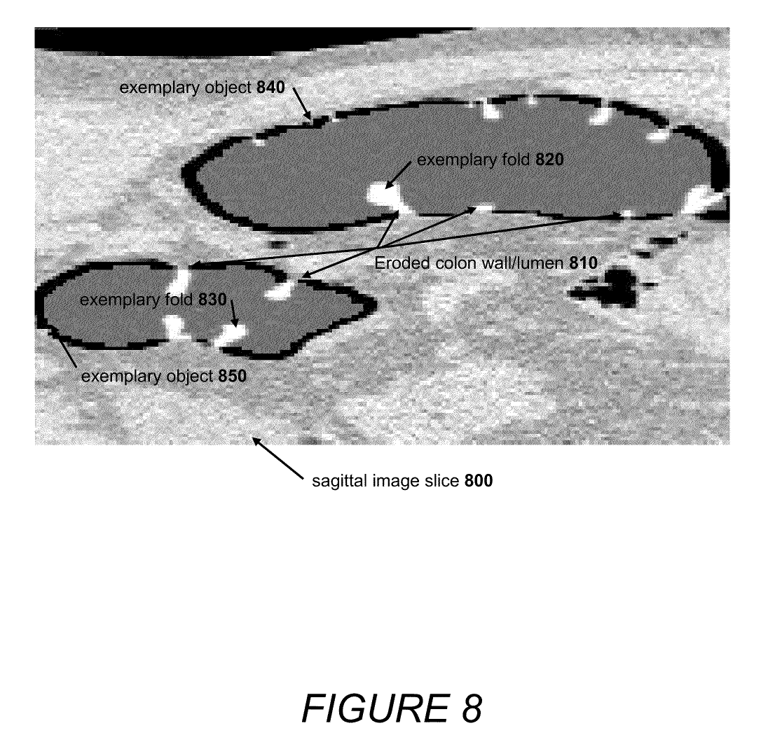

FIG. 8 is a sagittal image slice 800 illustrating a portion of a colon and an eroded wall/lumen of a colon 810 that may be obtained by performing the morphological erosion step with a structuring element size of 9 mm as described hereinabove on a mask representing closed colonic wall 710. The colonic lumen is illustrated in dark gray, and the eroded colonic wall in black. In sagittal image slice 800, numerous folds such as exemplary fold 820 and exemplary fold 830 can be seen. In FIG. 8, candidate fold objects are illustrated as white areas that overlay the eroded wall/lumen area illustrated in dark gray (lumen) and black (eroded wall). In contrast, note that numerous soft-tissue objects identified as part of closed colonic wall 810 such as exemplary object 840 and exemplary object 850 have been eroded and thus, will not be included in further analysis as potential folds.

In describing the structuring element sizes of the various morphological operations described hereinabove, one skilled in the art will appreciate that the exact structuring element size may be changed empirically, depending on numerous factors associated with the imagery in which the system and methods described herein are performed. For example, the structuring element size may be changed depending on the sharpness or resolution of the image data acquired, as a larger structuring element may be required given lower resolution image data and vice versa. In particular, CT and MR typically acquire colon imagery at different resolutions and may therefore require different structuring element sizes to adequately realize the system and methods described herein.

From a segmented representation of the colonic wall that protrudes into the colonic lumen, one means for then segmenting a representation of each individual candidate fold object from other image units of non-tissue in the colonic lumen is to perform a simple thresholding operation. Folds are soft tissue structures and exhibit an intensity range that is suitably different from other image units of colonic air, tagged colonic fluid, and other tagged objects such as stool. In embodiments where the intensity thresholding operation is performed on CT imagery, contiguous image elements having intensities within the range of −650 and 300 Hounsfield Units may be identified as candidate fold objects. A histogram analysis of the image data may be required and performed to obtain suitable parameters for an intensity thresholding operation on non-normalized imagery, such as MR imagery. A filtering step in which objects less than a certain size are removed (e.g., 15 cubic millimeters in volume) may also be performed to eliminate non-fold objects from consideration. This eliminates small objects formed possibly from the curvature of the colonic perimeter or portions of sessile polyps that are of non-interest. One skilled in the art will appreciate that the fold objects themselves are not complicated and thus, do not further require a segmentation operation; however, any suitable segmentation algorithm such as, but not limited to, an active contour or a deformable model segmentation algorithm could be performed on each individual candidate fold object obtained after performing the thresholding operation described hereinabove to further refine the exact pixels or voxels of the candidate fold object.

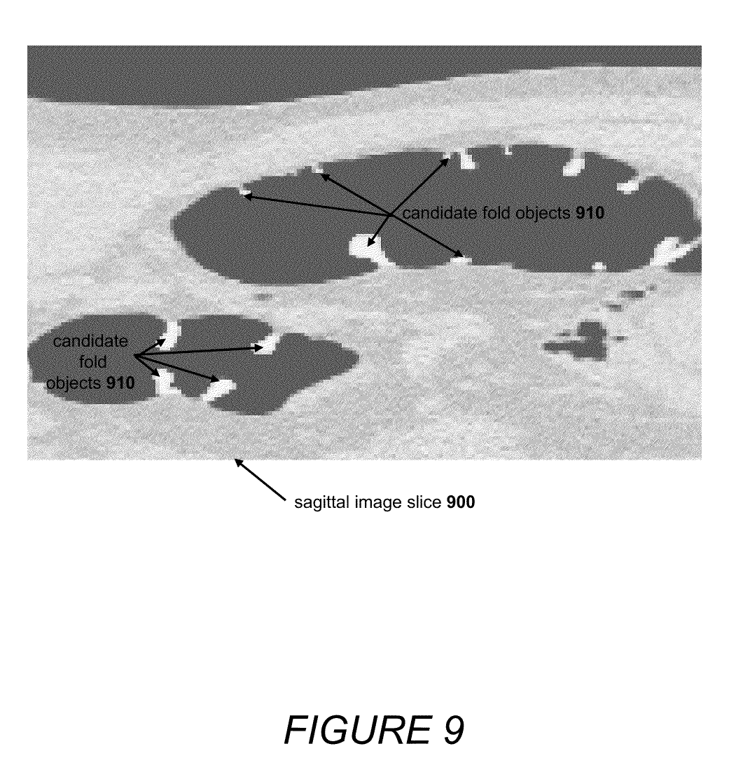

FIG. 9 is a sagittal image slice 900 illustrating a plurality of candidate fold objects 910 that may be identified by performing the intensity thresholding steps described hereinabove. Candidate fold objects 910 are illustrated in white. In sagittal image slice 900, candidate fold objects 910 are depicted using a mask that may be formed as an output from the aforementioned operational steps.

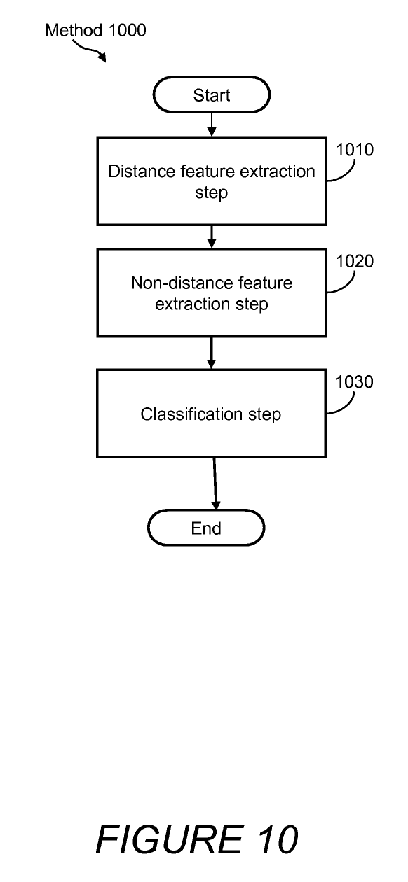

Again referencing FIG. 2, while candidate fold detection step 222 automatically detects fold objects with a high level of accuracy, false positives or non-fold-objects (e.g., pedunculated polyps or portions of sessile polyps) may also be detected. This occurs because, in certain colons, these types of objects may protrude into and/or cross the colonic lumen and exhibit similar intensities as folds. Candidate fold classification step 224 serves to eliminate these objects by classifying each detected object based on the likelihood that an object is a fold. Important features that describe fold-like structures include but are not limited to whether an object connects opposing regions of the colonic wall, the volume of the object, and the distribution of the object's points in contact with the colonic wall. FIG. 10 is a flowchart showing a method 1000 that may be performed to classify folds at step 224 in accordance with one embodiment of this disclosure. As shown in FIG. 10, the overall steps performed in method 1000 include a distance feature extraction step 1010 for measuring various distance features of each candidate fold object, a non-distance feature extraction step 1020 for measuring other features of each candidate fold object, and a classification step 1030 for classifying each fold based on the exhibited distance and non-distance feature metrics. Having briefly introduced the overall steps performed in FIG. 10, we will now further describe each step.

When comparing folds against false positives that protrude into the colonic lumen and thus may also have been selected in step 222, folds will typically span a greater distance across and often connect opposing regions of the colonic lumen while false positives will typically not. For example, referring back to exemplary fold 320 of FIG. 3, it can be seen that fold 320 connects to opposing regions of colon 310 at points 330 and 340, for example.

Thus, again referencing FIG. 10, distance feature extraction step 1010 is performed to compute various distance feature metrics on each segmented candidate fold object. To compute such distance metrics, the image units of a candidate fold object are referenced starting from a common image unit, which may be experimentally set. Ideally, the common image unit should be located outside of the colon to adequately measure such distance metrics. The referencing may be accomplished by performing a distance map calculation, a watershed algorithm, or other suitable reference labeling technique known in the art. Reference labeling techniques such as a distance map begin at a common image unit and label each adjacent image unit with an incremental value that may be specified in engineering units. Any useful distance feature metrics may then be computed to measure whether the object connects two opposing regions of the colonic interior. In certain embodiments, distance label measurements (i.e., distance labels) from the common image unit to image units where the candidate fold object touches either the colonic wall segmented at step 410 or morphologically eroded colonic wall at step 420 may be computed. For example, and not by way of limitation, a maximum distance value minus minimum distance value, a standard deviation of distance values, or a skewness of distance values may be feature metrics computed at step 1010 for characterizing folds from non-folds. One would expect a distribution of distance labels would be bimodal or multimodal more often for fold structures since they connect opposing sides of the colonic surface.

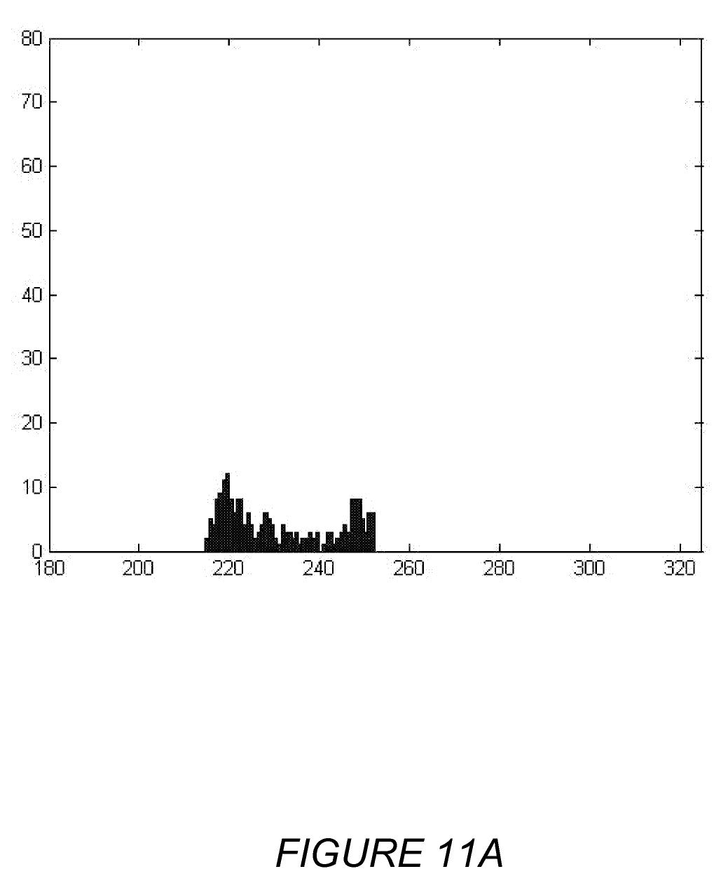

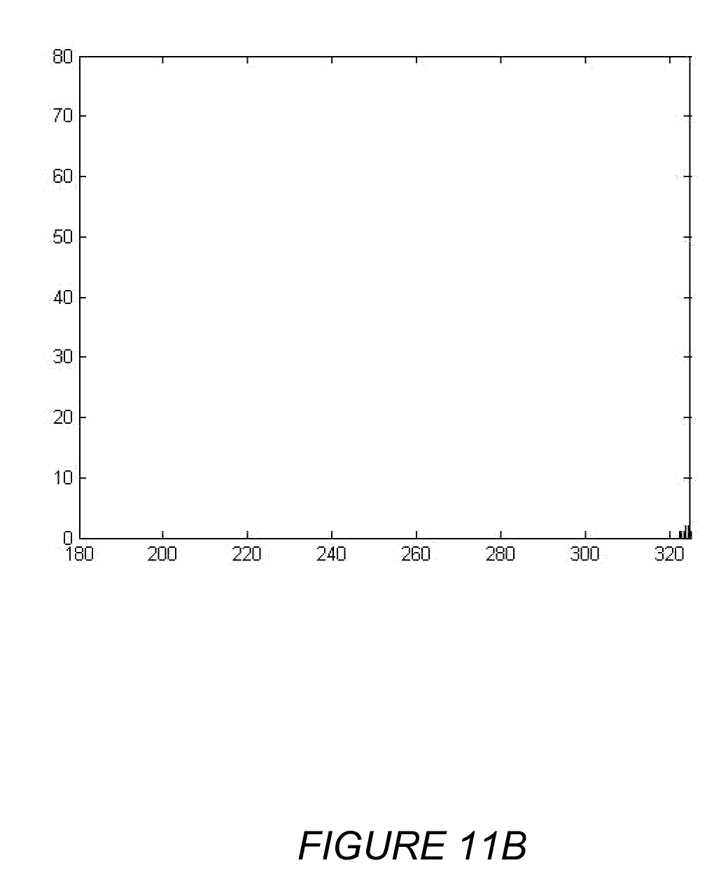

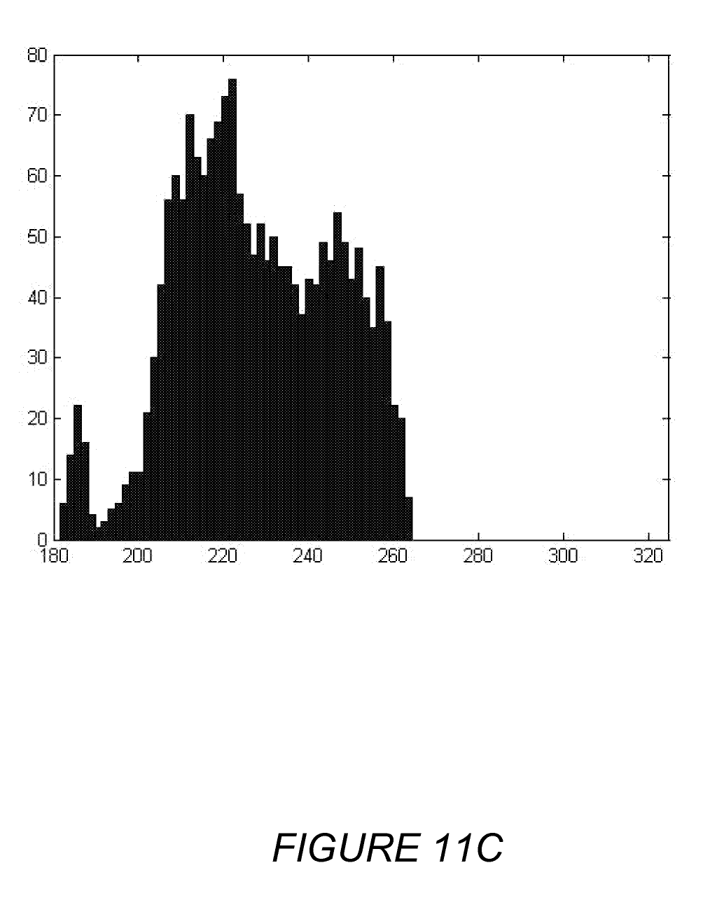

FIG. 11A illustrates a distance label histogram of a fold, while FIG. 11B illustrates an example of a distance label histogram of a non-fold, both of which may be computed at step 1010. The x-axis of each histogram describes the distance from a common image unit to image units where the candidate fold object touches the eroded colonic wall. The y-axis of each histogram describes the number of voxels at each computed distance point. Note that in FIG. 11A, the range of distance points along the x-axis is quite large while in FIG. 11B, the range is much smaller. Thus, FIG. 11A describes an object that spans across a larger section of the colon wall and thus, has a higher probability of being a fold. Furthermore, note the distribution of distance points in FIG. 11A versus FIG. 11B. The bimodal distribution of distance points in FIG. 11A describes an object that intersects the eroded colon wall at several locations and has a higher probability of being a fold, as opposed to the object in FIG. 11B that intersects the colon wall at only one location. FIG. 11C illustrates a distance label histogram of yet another fold. While this object has a smaller range of distance values, the multi-modal distribution of this object is a unique characteristic of folds in poorly distended regions of the colon. Such a characteristic can be further computed and used at classification step 1030 to discriminate folds from non-folds.

While distance feature extraction step 1010 alone may provide suitable measurements for effectively classifying folds from false positives, a non-distance feature extraction step 1020 may also be performed either separately, or in joint combination with distance feature extraction step 1010, to compute a likelihood or probability that characterizes whether each object is a fold or non-fold. For example, features that describe the total volume (e.g., total number of pixels or voxels) of the candidate fold object or the amount of the candidate fold object that touches the colonic wall (e.g., total number and/or percentage of pixels or voxels) may be computed. Typically, a fold, particularly those in a well-distended colon, will be both larger and wider than other tissue objects (e.g., a small portion of a sessile polyp or part of a pedunculated polyp that may be folded over). Other features describing the shape index, curvature, and/or texture of the candidate fold object may be computed at step 1020 and used for classification.

Classification step 1030 is then performed on the extracted feature values resulting from steps 1010 and/or 1020 to assign each candidate fold object to either a fold or a non-fold class, or to assign a classifier probability of being a fold versus a non-fold, as is known in the art. In certain embodiments, a rules-based or probabilistic classifier such as a Naïve Bayes classifier may be constructed and used at step 1030. As is known in the art, a Naïve Bayes classifier assumes independence between each feature value computed. An initial probability statistic set at zero is increased or decreased by comparing the value of each feature metric against prior learning of the classifier. For example, feature metrics describing a large distance between opposing regions of a candidate fold object and/or a large volume of a candidate fold object may substantially increase the probability statistic. Such probability statistic rules may be derived through supervised or unsupervised learning of the examples of each feature metric value exhibited by samples of folds and samples of false positives, or may be established in other ways. The probability statistic computed by the classification algorithm is then compared against a classification threshold. The threshold may be determined and set empirically by applying the aforementioned feature metric and probability statistic computations to exemplar folds and fold-like false positives as part of a training process and choosing an operating point that classifies folds with a suitable sensitivity at an acceptable false positive rate. In certain embodiments, the classifier may be constructed to output a two-class decision. For example, if the probability exceeds the threshold, the classifier may be constructed to classify the object as in a “fold” class. Otherwise, the classifier may be constructed to classify the object as in a “false positive” class. False positives may then be rejected from further consideration as potential folds.

While in one embodiment a Naïve Bayes rule-based classifier may be used in performing classification step 1030, there are numerous other statistical classification algorithms that may also be suitable. Examples include, but are not limited to, other types of linear classifiers, quadratic classifiers, neural networks, Bayesian networks, support vector machines (SVMs), decision trees, k-nearest neighbors, or other classifiers known in the art of pattern recognition. (See Pattern Classification, Duda et al., John Wiley & Sons, New York, October 2000). One skilled in the art would understand that the features described hereinabove could be quantized into grammatical space and then classified using syntactical classification algorithms.

The classification steps described in reference to FIG. 10 need not be limited to being performed at step 224 on candidate fold objects identified at candidate fold detection step 222. Instead, the classification steps described may be useful in discriminating folds from non-folds that are identified using any alternate fold detection and segmentation techniques described in the prior art. Furthermore, the fold classification steps described hereinabove may be useful in determining if a region of interest manually identified by a physician is a fold or not. For example, again referencing FIG. 1, a representation of at least a portion of the colon may be displayed on GUI 140 to a physician or other user of image viewing station 120. Using input devices such as but not limited to keyboard 136 and/or mouse 138, the physician may select the pixels or voxels of a specific candidate fold object in the medical imagery. The automated fold classification steps described hereinabove may then be performed to compute and output classification information for the object on GUI 140. For example, the fold versus non-fold class assignment and/or the probability that the object belongs to a fold versus non-fold class may be visually presented to the radiologist at the location of the selected pixels or voxels.

Again referencing FIG. 2, there are numerous techniques for outputting the results of fold identification step 220 to assist a physician in the inspection of the colon, examples of which will be further described hereinbelow. Any such techniques may be performed as part of fold output step 230. For example, a mask representing folds detected in accordance with fold identification step 220 as described hereinabove, may be first stored as in memory unit 124 as a file. For example, the file may be formed in accordance with the Digital Imaging and Communications in Medicine (DICOM) structured report, which is well-known in the art of medical imaging. For further information describing how fold objects may be encoded into a DICOM structured report, see parts 3, 16, and 17 of the DICOM Standard: American College of Radiology-National Electrical Manufacturers Association (ACR-NEMA) Digital Imaging and Communications in Medicine (DICOM) Standard Version 3.0-2008.

As is visually depicted in FIG. 9, various images of the colon may then be rendered and displayed from the file on a graphical user interface such as GUI 140 in which the folds are specially depicted from the rest of the colon imagery using the computed fold mask. Again referencing FIG. 2 and fold output step 230, one particularly useful means for specially depicting folds may be to render and display the image units of fold objects with a different amount of transparency (or semi-transparency) than the rest of the colon imagery. In contrast to Makram-Ebeid et al. discussed supra, semi-transparency allows the physician to “see through” potentially obstructing candidate fold objects to portions of a colon that may contain critical objects requiring inspection, such as polyps or polyp-like normal tissue. Previously, a physician reviewing colon imagery may be required to inspect the colon from various angles or viewpoints to ensure all areas around folds of the colon are adequately inspected. The system and methods described herein may substantially reduce the time it takes a physician to inspect each colon by substantially reducing the amount of changing of viewing angles required of the physician around folds.

One suitable means for depicting candidate fold objects with the appearance of semi-transparency is alpha compositing. In alpha compositing, in addition to storing a color or grayscale value for each image unit of a candidate fold object in memory unit 124, an additional alpha parameter (i.e., an alpha value) may be set that specifies the amount of semi-transparency in which a candidate fold object should be rendered and displayed on GUI 140. In certain embodiments, any or all fold objects detected in accordance with the methods described hereinabove may be rendered with semi-transparency by first setting an alpha parameter value anywhere greater than 0 and less than 1, where 1 is completely opaque and 0 is completely transparent. In certain other embodiments which are described hereinbelow, only those fold objects that have a probability of obscuring a polyp-like anomaly may be made semi-transparent, so as to permit a physician to not have his vision obscured by folds in proximity to a polyp-like anomaly.

There are numerous means described in the prior art for displaying colon imagery (e.g., CT or MR imagery of an abdominal region) in ways that are suitable for a physician to inspect a colon on an output device such as GUI 140. Any such means may be suitable for rendering and displaying both the colon imagery and the fold objects detected at fold identification step 220 hereinabove including, but not limited to: U.S. Pat. Nos. 5,782,762, 5,920,319, 6,083,162, 6,272,366, 6,366,800, 6,694,163, 6,909,913, and 7,149,564 to Vining et al.; U.S. Pat. Nos. 5,891,030 and 6,928,314 to Johnson et al. For example, the system and methods described herein may be particularly useful for physicians reviewing virtual endoscopic or “fly-through” views of the colon.

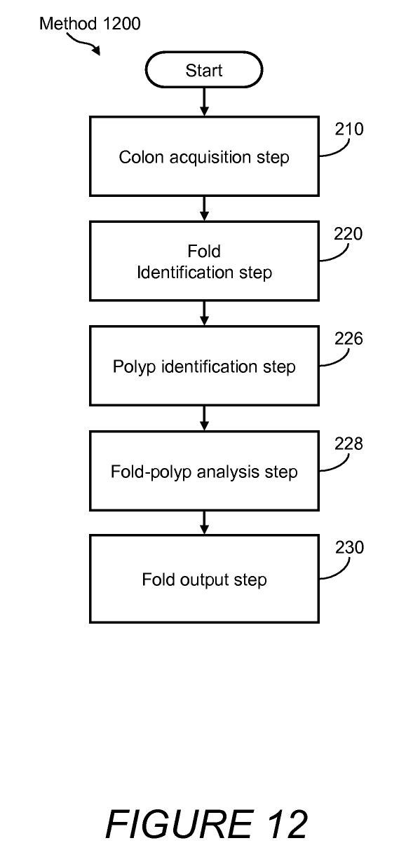

Another means for improving a physician's ability to inspect a colon may be derived by combining the automatic fold detection methods described hereinabove with an automated polyp detection method, the latter of which is well-known in the prior art. FIG. 12 is a flowchart showing a method 1200 of automatically detecting the folds of an anatomical colon in conjunction with polyp detection. The method may be performed using system 100 or other suitable computer system. As shown in FIG. 12, independent from the fold identification steps described hereinabove in conjunction with FIG. 2 (step 210 for colon acquisition and step 220 for fold identification), a polyp identification step 226 is performed to identify polyp-like areas of the colon; and a fold-polyp analysis step 228 then is performed to identify folds of interest based on the results of the polyp-like areas identified in the colon. These steps will now be described in further detail.

In polyp identification step 226, measures of curvature, shape index, sphericity, or combinations thereof may be used as a means to identify the image elements (e.g., the pixels or the voxels) known to exhibit the general characteristics of polyps. Such measures are well-known in the art. One suitable means or “polyp detection algorithm” can be seen in U.S. Pat. No. 7,236,620, “Computer-aided detection methods in volumetric imagery,” which is incorporated herein by reference. In this patent, polyp-like anomalies are identified using spherical summation means. The overall number of false positives that may be detected using such “polyp detection algorithms” may be substantially reduced by further processing each detected polyp-like anomaly using a classification method. Suitable algorithms for classifying polyps from normal tissue (i.e., false positives) include, but are not limited to, those described in references such as: “Computer-assisted detection of colonic polyps with CT colonography using neural networks and binary classification trees,” Medical Physics, Volume 30, Issue 1, pp. 52-60 (January 2003) by Jerebko et al.; “Multiple Neural Network Classification Scheme for Detection of Colonic Polyps in CT Colonography Data Sets,” Academic Radiology, Volume 10, Issue 2, Pages 154-160 by Jerebko et al.; “Support vector machines committee classification method for computer-aided polyp detection in CT colonography,” Academic Radiology, Volume 12, Issue 4, Pages 479-486, by Jerebko et al.; U.S. Pat. No. 7,260,250 to Summers et al.; U.S. Pat. No. 7,440,601 to Summers et al.; U.S. application Ser. No. 12/179,787 to Collins et al; and U.S. application Ser. No. [insert], “Computer-Assisted Analysis Of Colonic Polyps By Morphology In Medical Images” to Van Uitert et al.

Thus, given that each candidate fold object detected and each polyp-like anomaly detected is represented by image units having a particular location in the colon imagery, various polyp-fold location comparisons may then be computed at fold-polyp analysis step 228.

In one example of a simple yet useful analysis of polyp-like anomaly detections and fold-like detections, a computation may be made that determines whether a polyp-like anomaly overlaps or is adjacent to at least one candidate fold object. For example, a binary mask representing polyp-like anomalies detected and/or classified in the colon as suspicious may be logically ANDed with a binary mask representing candidate fold objects detected using any or all of the methods described hereinabove. Candidate fold objects in contact with (i.e., overlapping or bordering) a polyp-like anomaly can be labeled as belonging to a first class, while polyp-like anomalies that are not in contact with a candidate fold object can be labeled as belonging to a second class. Candidate fold objects in contact with or adjacent to a polyp-like anomaly may be specially depicted using the semi-transparency technique described above, so as to allow the physician to “see through” the candidate fold object to the anomaly near or adjacent to the fold. This solves the problem that the polyp-like anomaly might otherwise be obstructed by the fold and thus, the chance that the polyp-like anomaly is missed by the physician would therefore be reduced.

In a further example of a useful comparison between polyp-like anomalies and fold-like objects, a distance map, which may be readily available in embodiments where distance features are computed to classify candidate fold objects at step 1010, may further be used as a means to determine the likelihood that a polyp-like anomaly that is not on a candidate fold object may be obscured by a nearby candidate fold object during inspection viewing. For example, using a distance map, distance measurements may be computed from a common image element reference point at which a polyp-like anomaly touches the colon wall to the point at which the nearest candidate fold object touches the colon wall. The distance measurements may further be classified with other important features (e.g., height of the polyp-like anomaly, height of the candidate fold object) to derive a probability or likelihood of obscuration. Generally speaking, a polyp-like anomaly that is located within a small distance from a candidate fold object and is small in comparison to the candidate fold object is more likely to be obscured and thus, may warrant special depiction at this colon location to assist the physician in inspection. This would help ensure that areas of a colon in which a polyp-like object may be in contact with or proximate to a candidate fold object are carefully reviewed. Previously, no such assistance was provided to assist an inspecting physician. For example, the candidate fold object may be displayed with semi-transparency, as previously described. An indicator may be displayed in the colon to direct the radiologist to review the location of the polyp-like anomaly. Alternatively, the candidate fold object may be electronically “subtracted” from the colon (i.e., the image units of the fold may be made completely transparent) so as to leave a region that may appear as colonic air. Areas of imagery adjacent to the subtracted objects may be smoothed using a Gaussian filter or other suitable technique to minimize artifacts. In such embodiments where the candidate folds are electronically subtracted, to avoid subtracting a fold having a polyp-like anomaly of interest to the physician, ideally, polyp identification step 226 may be performed at or near 100% sensitivity.

Any of the aforementioned special depiction techniques or variables in which to turn on/off the special depiction technique may further be implemented and stored as an “option” in memory unit 124 of image viewing station 120. Each “option” and/or variable may further be presented graphically to a user via GUI 140 and may be selected or changed via an input interface 126 such as keyboard 136, mouse 138, and/or other suitable device. The option may be presented, for example, as a slider bar control (as for example to control degree of transparency), on/off toggle, etc. and the options may be specified or changed either prior to, during, or after the depiction of fold objects detected in accordance with the methods disclosed herein.

In addition to specially depicting fold objects detected, any information computed during the fold detection process may also be presented visually to the physician to aid the inspection of the colon. For example, a reference pattern, a reference color, or a reference label may be presented on or near (i.e., proximate to) each candidate fold object so as to provide the physician with reference landmarks. Such landmarks may be particularly useful in embodiments where the physician reviews multiple images of the same colon, such as the prone and the supine views of a colon, and needs to visually correlate objects or locations in multiple views. The corresponding sets of fold landmarks may also be uniquely depicted. For example, fold landmark with reference number #1 may be colored with a blue mark in each image; fold landmark with reference #2 may be colored with a yellow mark in each image, etc. Other computed information that may be presented includes the feature metric values computed during statistical classification as described hereinabove, which may be useful for a physician in evaluating the suspiciousness of a structure; or the individual probability statistics computed for each feature value metric during statistical classification as described hereinabove; which may be useful for a physician in understanding how and why an automated, computer-implemented decision was made to specially depict certain candidate fold objects in the colon.

It is noted that terms like “preferably,” “commonly,” and “typically” are not utilized herein to limit the scope of this disclosure or to imply that certain features are critical, essential, or even important to the structure or function of the methods and systems disclosed herein. Rather, these terms are merely intended to highlight alternative or additional features that may or may not be utilized in a particular embodiment.

Having described the methods and systems disclosed herein in detail and by reference to specific embodiments thereof, it will be apparent that modifications and variations are possible without departing from the scope of this disclosure. More specifically, although some aspects of this disclosure may be identified herein as preferred or particularly advantageous, it is contemplated that the methods and systems disclosed herein are not necessarily limited to these preferred aspects.

1. A computer-implemented method of presenting colonic folds in a colon under study to a user comprising:
a) receiving, through at least one input device, digital imagery representing at least a portion of a colon;
b) using at least some of said digital imagery, detecting, in at least one processor, at least one candidate colonic fold in said at least a portion of a colon;
c) classifying, in at least one processor, at least one of said candidate colonic folds as a colonic fold; and
d) outputting, through at least one output device, information identifying said at least one candidate colonic fold which was classified as a colonic fold.

2. The method of claim 1, wherein detecting at least one candidate colonic fold comprises:
b1. performing a colonic wall segmentation step; and
b2. based upon the colonic wall segmentation, performing a candidate fold segmentation step,
wherein a colonic wall segmentation includes soft tissue objects protruding from said wall into the lumen of said colon.

3. The method of claim 2, wherein performing the colonic wall segmentation step comprises performing at least one of an active contour method, a level set method, and a CT value and CT gradient method.

4. The method of claim 2, wherein performing the colonic wall segmentation step comprises:
b1a. performing a colon lumen segmentation step; and
b1b. based upon the colonic lumen segmentation, performing a colon wall identification step.

5. The method of claim 4, wherein performing the colonic lumen segmentation step comprises:
b1a1. segmenting a representation of air of said colon; and
b1a2. segmenting a representation of fluid of said colon.

6. The method of claim 4, wherein performing the colonic wall identification step comprises performing at least one of a local convex hull operation and a morphological closing operation.

7. The method of claim 2, wherein performing the candidate fold segmentation step comprises:
b2a. performing an erosion of the colonic wall; and
b2b. based on the colonic wall erosion, performing a thresholding operation on the eroded colon wall.

8. The method of claim 7, wherein performing an erosion of the colonic wall comprises performing at least one of a morphological erosion, an active contour, or a distance transform operation.

9. The method of claim 7, wherein performing an erosion of the colonic wall comprises:
b2a1. performing a first operation on said colon wall to identify a body of said at least one candidate colonic fold; and
b2a2. performing a second operation on said colon wall to identify a base of said at least one candidate colonic fold.

10. The method of claim 1, wherein classifying at least one of said candidate colonic folds as a colonic fold comprises
c1. performing at least one of a distance feature extraction step and a non-distance feature extraction step on the candidate colonic fold; and
c2. based upon the at least one of the distance feature extraction step and the non-distance feature extraction step performed, performing a classification step.

11. The method of claim 10 wherein performing a distance feature extraction step comprises computing at least one distance measurement from a common voxel point to voxel points along a boundary where said candidate colonic fold meets said colon wall.

12. The method of claim 10 wherein performing a non-distance feature extraction step comprises computing at least one of a volume feature, a feature describing the amount the candidate colonic fold touches the colonic wall, a shape index feature, a curvature feature, and a texture feature.

13. The method of claim 10, wherein performing a classification step comprises:
c2a. computing a discriminant score from at least one of a distance feature measurement extracted and a non-distance feature measurement extracted; and
c2b. classifying said at least one candidate colonic fold based on said discriminant score computed.

14. The method of claim 10, wherein the classification is a binary decision as to whether the candidate colonic fold is a colonic fold.

15. The method of claim 10, wherein the classification is a probability as to whether the candidate colonic fold is a colonic fold.

16. The method of claim 1, wherein said outputting comprises:
d1. displaying digital imagery representing at least a portion of the colon on at least one output device; and
d2. specially depicting said at least one candidate colonic fold which was classified as a colonic fold in said at least a portion of the colon displayed.

17. The method of claim 16 further comprising: in said special depiction of said at least one candidate colonic fold which was classified as a colonic fold, displaying the said at least one candidate colonic fold which was classified as a colonic fold at least partially transparently.

18. The method of claim 16, wherein at least a portion of the digital imagery representing at least a portion of a colon derives from a non-invasive imaging method.

19. The method of claim 18, wherein the non-invasive imaging method is selected form the set composed of CT scanning and MRI imaging.

20. A computer-readable medium having computer-readable instructions stored thereon which, as a result of being executed in a computer system having at least one processor, at least one output device and at least one input device, instructs the computer system to perform a method of presenting colonic folds in a colon under study to a user, comprising:
a) receiving, through at least one input device, digital imagery representing at least a portion of a colon;
b) using at least some of said digital imagery, detecting, in at least one processor, at least one candidate colonic fold in said at least a portion of a colon;
c) classifying, in at least one processor, at least one of said candidate colonic folds as a colonic fold; and
d) outputting, through at least one output device, information identifying said at least one candidate colonic fold which was classified as a colonic fold.

21. The computer-readable medium of claim 20, wherein detecting at least one candidate colonic fold comprises:
b1. performing a colonic wall segmentation step; and
b2. based upon the colonic wall segmentation, performing a candidate fold segmentation step,
wherein a colonic wall segmentation includes soft tissue objects protruding from said wall into the lumen of said colon.

22. The computer-readable medium of claim 21, wherein performing the colonic wall segmentation step comprises performing at least one of an active contour method, a level set method, and a CT value and CT gradient method.

23. The computer-readable medium of claim 21, wherein performing the colonic wall segmentation step comprises:
b1a. performing a colon lumen segmentation step; and
b1b. based upon the colonic lumen segmentation, performing a colon wall identification step.

24. The computer-readable medium of claim 23, wherein performing the colonic lumen segmentation step comprises:
b1a1. segmenting a representation of air of said colon; and
b1a2. segmenting a representation of fluid of said colon.

25. The computer-readable medium of claim 23, wherein performing the colonic wall identification step comprises performing at least one of a local convex hull operation and a morphological closing operation.

26. The computer-readable medium of claim 21, wherein performing the candidate fold segmentation step comprises:
b2a. performing an erosion of the colonic wall; and
b2b. based on the colonic wall erosion, performing a thresholding operation on the eroded colon wall.

27. The computer-readable medium of claim 26, wherein performing an erosion of the colonic wall comprises performing at least one of a morphological erosion, an active contour, or a distance transform operation.

28. The computer-readable medium of claim 26, wherein performing an erosion of the colonic wall comprises:
b2a1. performing a first operation on said colon wall to identify a body of said at least one candidate colonic fold; and
b2a2. performing a second operation on said colon wall to identify a base of said at least one candidate colonic fold.

29. The computer-readable medium of claim 20, wherein classifying at least one of said candidate colonic folds as a colonic fold comprises
c1. performing at least one of a distance feature extraction step and a non-distance feature extraction step on the candidate colonic fold; and
c2. based upon the at least one of the distance feature extraction step and the non-distance feature extraction step performed, performing a classification step.

30. The computer-readable medium of claim 29 wherein performing a distance feature extraction step comprises computing at least one distance measurement from a common voxel point to voxel points along a boundary where said candidate colonic fold meets said colon wall.

31. The computer-readable medium of claim 29 wherein performing a non-distance feature extraction step comprises computing at least one of a volume feature, a feature describing the amount the candidate colonic fold touches the colonic wall, a shape index feature, a curvature feature, and a texture feature.

32. The computer-readable medium of claim 29, wherein performing a classification step comprises:
c2a. computing a discriminant score from at least one of a distance feature measurement extracted and a non-distance feature measurement extracted; and
c2b. classifying said at least one candidate colonic fold based on said discriminant score computed.

33. The computer-readable medium of claim 29, wherein the classification is a binary decision as to whether the candidate colonic fold is a colonic fold.

34. The computer-readable medium of claim 29, wherein the classification is a probability as to whether the candidate colonic fold is a colonic fold.

35. The computer-readable medium of claim 20, wherein said outputting comprises:
d1. displaying digital imagery representing at least a portion of the colon on at least one output device; and
d2. specially depicting said at least one candidate colonic fold which was classified as a colonic fold in said at least a portion of the colon displayed.

36. The computer-readable medium of claim 35 further comprising computer-readable instructions stored thereon which, as a result of being executed in the computer system, instructs the computer system to, in said special depiction of said at least one candidate colonic fold which was classified as a colonic fold, display the said at least one candidate colonic fold which was classified as a colonic fold at least partially transparently.

37. The computer-readable medium of claim 35, wherein at least a portion of the digital imagery representing at least a portion of a colon derives from a non-invasive imaging method.

38. The computer-readable medium of claim 37, wherein the non-invasive imaging method is selected form the set composed of CT scanning and MRI imaging.

39. A system for presenting colonic folds in a colon under study to a user, comprising a computer system with at least one processor, at least one input device and at least one output device, so configured that the system is operable to:
a) receive, through at least one input device, digital imagery representing at least a portion of a colon;
b) using at least some of said digital imagery, detect, in at least one processor, at least one candidate colonic fold in said at least a portion of a colon;
c) classify, in at least one processor, at least one of said candidate colonic folds as a colonic fold; and
d) output, through at least one output device, information identifying said at least one candidate colonic fold which was classified as a colonic fold.

40. The system of claim 39, wherein detecting at least one candidate colonic fold comprises:
b1. performing a colonic wall segmentation step; and
b2. based upon the colonic wall segmentation, performing a candidate fold segmentation step,
wherein a colonic wall segmentation includes soft tissue objects protruding from said wall into the lumen of said colon.

41. The system of claim 40, wherein performing the colonic wall segmentation step comprises performing at least one of an active contour method, a level set method, and a CT value and CT gradient method.

42. The system of claim 40, wherein performing the colonic wall segmentation step comprises:
b1a. performing a colon lumen segmentation step; and
b1b. based upon the colonic lumen segmentation, performing a colon wall identification step.

43. The system of claim 42, wherein performing the colonic lumen segmentation step comprises:
b1a1. segmenting a representation of air of said colon; and
b1a2. segmenting a representation of fluid of said colon.

44. The system of claim 42, wherein performing the colonic wall identification step comprises performing at least one of a local convex hull operation and a morphological closing operation.

45. The system of claim 40, wherein performing the candidate fold segmentation step comprises:
b2a. performing an erosion of the colonic wall; and
b2b. based on the colonic wall erosion, performing a thresholding operation on the eroded colon wall.

46. The system of claim 45, wherein performing an erosion of the colonic wall comprises performing at least one of a morphological erosion, an active contour, or a distance transform operation.

47. The system of claim 45, wherein performing an erosion of the colonic wall comprises:
b2a1. performing a first operation on said colon wall to identify a body of said at least one candidate colonic fold; and
b2a2. performing a second operation on said colon wall to identify a base of said at least one candidate colonic fold.

48. The system of claim 39, wherein classifying at least one of said candidate colonic folds as a colonic fold comprises
c1. performing at least one of a distance feature extraction step and a non-distance feature extraction step on the candidate colonic fold; and
c2. based upon the at least one of the distance feature extraction step and the non-distance feature extraction step performed, performing a classification step.

49. The system of claim 48 wherein performing a distance feature extraction step comprises computing at least one distance measurement from a common voxel point to voxel points along a boundary where said candidate colonic fold meets said colon wall.

50. The system of claim 48 wherein performing a non-distance feature extraction step comprises computing at least one of a volume feature, a feature describing the amount the candidate colonic fold touches the colonic wall, a shape index feature, a curvature feature, and a texture feature.

51. The system of claim 48, wherein performing a classification step comprises:
c2a. computing a discriminant score from at least one of a distance feature measurement extracted and a non-distance feature measurement extracted; and
c2b. classifying said at least one candidate colonic fold based on said discriminant score computed.

52. The system of claim 48, wherein the classification is a binary decision as to whether the candidate colonic fold is a colonic fold.

53. The system of claim 48, wherein the classification is a probability as to whether the candidate colonic fold is a colonic fold.

54. The system of claim 39, wherein said outputting comprises:
d1. displaying digital imagery representing at least a portion of the colon on at least one output device; and
d2. specially depicting said at least one candidate colonic fold which was classified as a colonic fold in said at least a portion of the colon displayed.

55. The system of claim 54 wherein the system further is operable, in said special depiction of said at least one candidate colonic fold which was classified as a colonic fold, to display the said at least one candidate colonic fold which was classified as a colonic fold at least partially transparently.

56. The system of claim 54, wherein at least a portion of the digital imagery representing at least a portion of a colon derives from a non-invasive imaging method.

57. The system of claim 56, wherein the non-invasive imaging method is selected form the set composed of CT scanning and MRI imaging.

58. A computer-implemented method of presenting colonic folds in a colon under study to a user comprising:
a) receiving, through at least one input device, digital imagery representing at least a portion of a colon;
b) using at least some of said digital imagery, detecting, in at least one processor, at least a portion of a colonic wall in said at least a portion of a colon;
c) segmenting, in at least one processor, at least one candidate colonic fold from said at least a portion of a colonic wall; and
d) outputting, through at least one output device, information identifying said at least one candidate colonic fold which was segmented from said at least a portion of a colonic wall.

59. The method of claim 58 wherein detecting at least a portion of a colonic wall in said at least a portion of a colon comprises performing at least one of an active contour method, a level set method, and a CT value and CT gradient method.

60. The method of claim 58, wherein detecting at least a portion of a colonic wall in said at least a portion of a colon comprises:
b1a. performing a colon lumen segmentation step; and
b1b. based upon the colonic lumen segmentation, performing a colon wall identification step.

61. The method of claim 60 wherein performing the colonic lumen segmentation step comprises:
b1a1. segmenting a representation of air of said colon; and
b1a2. segmenting a representation of fluid of said colon.

62. The method of claim 60, wherein performing the colonic wall identification step comprises performing at least one of a local convex hull operation and a morphological closing operation.

63. The method of claim 58, wherein segmenting at least one candidate colonic fold from said at least a portion of a colonic wall comprises:
b2a. performing an erosion of the colonic wall; and
b2b. based on the colonic wall erosion, performing a thresholding operation on the eroded colon wall.

64. The method of claim 63, wherein performing an erosion of the colonic wall comprises performing at least one of a morphological erosion, an active contour, or a distance transform operation.

65. The method of claim 63, wherein performing an erosion of the colonic wall comprises:
b2a1. performing a first operation on said colon wall to identify a body of said at least one candidate colonic fold; and
b2a2. performing a second operation on said colon wall to identify a base of said at least one candidate colonic fold.

66. The method of claim 58 further comprising: classifying, in at least one processor, at least one of said candidate colonic folds segmented from said at least a portion of a colonic wall as a colonic fold.

67. The method of claim 66, wherein classifying at least one of said candidate colonic folds as a colonic fold comprises
c1. performing at least one of a distance feature extraction step and a non-distance feature extraction step on the candidate colonic fold; and
c2. based upon the at least one of the distance feature extraction step and the non-distance feature extraction step performed, performing a classification step.

68. The method of claim 67, wherein said outputting comprises:
d1. displaying digital imagery representing at least a portion of the colon on at least one output device; and
d2. specially depicting said at least one candidate colonic fold which was classified as a colonic fold in said at least a portion of the colon displayed.

69. A computer-generated user interface for presenting a graphical representation of a colon, the user interface comprising a depiction of the colon; wherein regions of the colon segmented as colonic folds are displayed at least partially transparent.
